(19) United States
(12) Patent Application Publication
(10) Pub. No.: US 2025/0288936 A1
(43) Pub. Date: Sep. 18, 2025

(54) METHOD FOR MANUFACTURING WHIRLWIND GENERATING APPARATUS FOR PURIFYING CONTAMINATED AIR

(71) Applicant: Sam Ju JEONG, Gwangju (KR)

(72) Inventor: Sam Ju JEONG, Gwangju (KR)

(21) Appl. No.: 18/689,792

(22) PCT Filed: Aug. 5, 2022
(86) PCT No.: PCT/KR2022/011647

§ 371 Date: Aug. 26, 2024

(30) Foreign Application Priority Data
Sep. 7, 2021 (KR) 10-2021-0119499

(51) Int. Cl. B01D 47/06

(52) U.S. Cl. CPC B01D 47/06

(57) ABSTRACT

The present invention relates to a method for manufacturing a whirlwind generating apparatus for purifying contaminated air, the whirlwind generating apparatus having, in a stacked and all-inclusive manner, a total of 8-stage components including: a first-stage water tank; a second-stage second suction chamber; a third-stage purifying and spraying chamber; a fourth-stage water droplet blocking chamber; a fifth-stage purified air suction chamber; a sixth-stage blower motor chamber; a seventh-stage whirlwind generating apparatus housing; and an eighth-stage whirlwind discharging apparatus, so as to purify air contaminated due to pollution in the earth's atmospheric environment.

### TECHNICAL FIELD

The present invention clearly and cleanly removes polluted air, such as yellow dust, fine dust, ultrafine dust, carbon dioxide, dust, automobile emissions, industrial emissions, aviation emissions, airship emissions, agricultural machinery emissions, subway emissions, forest fire pollution, fire pollution, smog, viruses and harmful bacteria, being a serious problem due to the opposite effect as the industrial society that our society is currently facing develops. Until now, the air polluted by pollution on Earth has been purified by rain, snow, and wind that fell from the sky. In addition to this, the present invention relates to a method for manufacturing a whirlwind generating apparatus for purifying the polluted air, to clearly and cleanly transform the air polluted by pollution in the earth's atmosphere by using the whirlwind generating apparatus for purifying the polluted air, so as to provide blue skies and purified clear air to crowded cities, humanity, and nature.

### BACKGROUND ART

In general, there are attempts to reduce Earth's air pollution through various methods and regulations, for example, developing low-emission vehicles, planting trees at the source of yellow dust, scraping old vehicles, reducing polluting industries, and developing hydrogen cars, electric cars and eco-friendly energy in order to remove or reduce contaminated air pollution. However the pollution is spreading further and people are facing a global crisis of climate change. The conventional technology includes an atmosphere scheme including a filter-type pollution purification, and an indoor scheme including a filter-type or wet-type air purifier/cleaner for purifying air inside a building. However, the effect is insignificant, filters remain as pollution, and bacteria remains on the filters. It fails to find out a method of stopping or purifying polluted air 1000 such as polluted air 1000 coming over mountains, fields and borders on land, polluted air 1000 coming over the sea, and polluted air 1000 coming over rivers. The present invention is configured with a total of 8 stages of components and structure including 6 internal stages and 2 external stages, in which a completed whirlwind generating apparatus 1 for purifying polluted air is installed in a predetermined location to purify the polluted air 1000 by using only predetermined purified water 300. For polluted air 1000 coming over the land, polluted air 1000 coming over the sea, polluted air 1000 coming over the river polluted air 1000 entering into a building, polluted air 1000 inside a large building, polluted air 1000 in a underground shopping mall, polluted air 1000 inside (outside) a school, polluted air 1000 in an apartment complex, polluted air 1000 inside (outside) a hospital, and polluted air in a military base, a department store, a commercial area, a dense building area, a urban area, an industrial complex area, a tunnel, a waiting room, a market, and the like, the apparatus is fixedly installed in a fixed installation area at a predetermined position and with a predetermined capacity and size. The whirlwind generating apparatus 1 is fixedly installed on a fixed frame barge at a predetermined position in the sea or river, so as to purify the polluted air 1000. Sea water 200-1 is used as purifying water 300 on the sea, and river water 200-3 is used as the purifying water 300 on the river. The present applicant is the same person as the applicants of the applications of Application No. 10-2021-0119499, Application No. 10-2018-0091331, Application No. 10-2019-0063625, Application No. 10-2020-0047288, Application No. 10-2021-0031852, which are previously piled by the present inventor.

In areas or places that require movable installation, the polluted air 1000 is purified more effectively while moving in a road movable purification type suitable for capacity and size, a rail movable purification type, an elevator movable purification type, a car trailer type, a tilting rotation type, a ship movable type installed on board the sea, or a ship movable type installed on board in the river. Since people wear masks and close windows when going to school, going to work, going out, shopping, eating out, or traveling, and restrain or reduce going outside due to various pollutions such as yellow dust and fine dust without the present invention, and accordingly the number of customers in streets, markets, malls and stores decreases, stores go bankrupt and close, the market economy gradually collapses, sales decrease, and thus the national economy may stagnate. In addition, people on Earth die prematurely due to the polluted air 1000 such as fine dust, which is more than the 7 million people who die each year.

### DOCUMENT OF RELATED ART

(Patent Document) KR Publication No. 10-1181546
(Patent Document) KR Publication No. 20-2048234
(Non-Patent Document) KR Publication No. 10-2018-0012021
(Non-Patent Document) KR Publication number: 2003-008606

### DISCLOSURE

### Technical Problem

Until now, it rains, snows and winds to help purify the polluted air 1000 in the Earth's atmosphere. There has been an attempt for purifying the polluted air (1000) in an area with severe polluted air (1000) by sucking the polluted air (1000), limiting clean water (100 and 200), and making purifying water (300) fall like rain. However, the purification effect is weak in a limited area and space. When the water is sprayed like a mist, the fine dust, ultrafine dust, yellow dust and the like sucked in are not effectively purified.

### Technical Solution

When the polluted air is purified by elaborately forming an ejecting structure provided with a water ejection adjusting tool (16) for ejecting the water (100 and 200), a stream of the purifying water (100 and 200) is ejected long and quickly, so that the polluted air (1000) may be purified quickly and even the ultra-fine dust, smoke, and odors, which cannot be purified by filters, may be purified. For the purifying water (100 and 200) used in the present invention, it may be limited to drinking water (100) permitted by the country, such as tap water (100-1), spring water (100-2), groundwater (100-3) and bedrock water (100-4). In areas or places without the above purifying water, alternative purifying water 200, such as sea water (200-1), saline water (200-2), and river water (200-3) as water of the second quality or higher permitted by the country, is used and necessary water 250 is used in areas and places without the above purifying water (100 and 200), and limited river water (250-1) as water of the third quality permitted by the country. The apparatus to the present invention may be manufactured using iron materials, non-iron materials, alloy materials, resin materials, FRP materials, iron-resin mixed materials, non-iron-resin mixed materials, beam steel materials, and titanium materials. In this description, it may be formed of steel materials, steel plates, poles, beam steel materials, and stainless steel pipes, stainless steel plates, stainless steel valves, zinc pipes, and stainless steel pipes. The purchased products required for the system, such as control devices, cameras, autonomous driving devices, artificial intelligence electronic devices, oxygen generators, automatic control devices, control boxes, distribution boards, safety devices, and piping equipment, may be purchased and ordered for use. The apparatus used in the specification will be described as an apparatus formed of stainless steel which is preferable hygienically and resistant to corrosion as t is rarely dissolved in moisture and saline water, or the manufacturing method 1 will be described as partially using steel bars and beam steel. For convenience, general welding, special welding, argon welding, stainless steel welding, and laser welding used in the present invention will be collectively referred to as welding. The apparatus according to the present invention may be formed in a circular or square shape, or externally in a pentagonal, hexagonal, octagonal or other shape. The manufacturing method according to the present invention includes an on-site manufacturing method and a factory manufacturing method. For convenience, all cutting devices, such as an oxygen cutter, a laser cutter, a plasma cutter, and a hydraulic cutter, used for cutting in the present invention will be collectively referred to as a cutter. For convenience, electricity, a solar cell, a generator, an engine and the like used in the present invention will be collectively referred to as a power source. A derrick, a hoist, a crane, a chain block, a lift, and an elevator used in the present invention will be collectively referred to as a moving device for convenience in installation and use thereof. The present invention is configured to include a total of 8 stages, including stages for forming an interior, such as a first-stage water tank (4), a second-stage second suction chamber (9), a third-stage second purifying and spraying chamber (10), a fourth-stage water droplet blocking chamber (11), a fifth-stage purified air suction chamber (13) and a sixth-stage blower motor chamber (14); and stages for forming an exterior, such as a seventh-stage whirlwind generating apparatus housing (2) and an eighth-stage whirlwind discharging apparatus (15 and 22). In the first-stage water tank (4), one or more pipes (7) for purifying water (100) (200) (250) and one or more drain holes (8) are formed at predetermined positions of an internal structure on a base plate (3) of the water tank (4), one or more pipes (7) for purifying water (100) (200) (250) and one or more drain holes (8) are formed outside the internal structure, and a water guide plate (4-1) is formed at least 5 degrees higher than the drain hole (8); a plurality of second suction ports (9-1) are formed on a side circumference of a cylinder in the second-stage second d suction chamber (9); the third-stage secondary purifying and spraying chamber (10) and a water reflection plate (10-1) are formed; the fourth-stage water droplet blocking chamber (11) is formed; the fifth-stage purified air suction chamber (13) is formed; the sixth-stage blower motoring chamber (14) and a fan (14-2) are formed; the seventh-stage whirlwind generating apparatus housing (2) is formed to form a first suction hole (2-1), a primary purifying and spraying chamber (2-2) and a blocking net (2-3); and the eighth-stage whirlwind discharging apparatus (15), a purified air whirlwind discharging apparatus (22), and a whirlwind blade formed in the whirlwind discharging apparatus are formed; thereby completing a stacked structure according to the stages or completing a work integrated from bottom to top or from top to bottom by forming internal and external frameworks formed from a base.

The working scheme may be selected depending on the installation area or place. For convenience, the title of the present invention: “method for manufacturing a whirlwind generating apparatus for purifying contaminated air” will be collectively referred to as a “whirlwind-generating apparatus manufacturing method”. Next, the present invention is completed as shown in FIG. 1. Although every country has made efforts to overcome the global crisis of climate change by developing hydrogen cars, electric cars, and eco-friendly energy in order to improve the atmosphere environment, pollution is becoming more widespread. In the related arts, purifying the atmospheric air is insignificant and temporary since the operation is required to be stopped during replacement of filters and the filters are pollution again. However, the completed apparatus of the present invention does not require filter replacement. In addition, the present invention is configured such that the polluted air (1000) containing ultra-fine carbon dioxide, exhaust smoke, bad odors, viruses, and harmful bacteria sucked into the first suction port (2-1) after being failed to be purified by the filter is primarily struck and purified in the primary purifying and spraying chamber (2-2) by using clean purifying water (100, 200 and 250); the polluted air (1000) is secondarily struck and purified by the purifying water (100, 200 and 250) ejected from the water ejection adjusting tool (16) precisely arranged in the secondary purification chamber; the ejected water is reflected on the water reflection plate elaborately formed by a mold and tertiarily hits the polluted air; the water (100 and 200) ejected strongly and quickly collides with each other to quaternarily hit the polluted air so as to exterminate viruses and harmful bacteria in the polluted air (1000), continuously ejected water bombs (water droplets) cleanly purify the polluted air (1000), and sink in the purifying water (100, 200 and 250) and flow into the water tank (4), so as to be discharged through the drain hole formed in the water tank (4). A purchased drainage purification tank (800) is installed together on the sea or river. The purifying power of the present invention is characterized by the method for manufacturing the whirlwind generating apparatus for purifying the polluted air (1000) from the building interior using the clean water (100 and 200). The daily purification area of the large/medium-sized standard of the present invention corresponds to a green forest mountain with a height of approximately 500 m and a square width of 12 km. Herein, the above numeral values may change depending on the weather.

### Advantageous Effects

In addition, according to the advantageous effect of the present invention, purified air (2000) due to a low temperature of the purifying water (100 and 200) ejected in the whirlwind-generating apparatus manufacturing method (1) can decrease the high temperature of 38° C. by 1° C. to 5° C. or more when a heat wave occurs in the summer. In addition, purified air (2000) due to a high temperature of the purifying water (100 and 200) ejected in the whirlwind-generating apparatus manufacturing method (1) can increase the low temperature of −15° C. by 1° C. to 5° C. or more when a cold wave occurs in the winter. The advantageous effect of the present invention is not limited thereto. According to the present invention, the power is turned off (OFF) on rainy days, snowy days, gusty days, very windy days, or when a typhoon begins.

### DESCRIPTION OF DRAWINGS

FIG. 1 is an overall complete diagram of the method for manufacturing a whirlwind generating apparatus for purifying a polluted air of the present invention.

FIG. 2 is a front view of a whirlwind generating apparatus housing of the present invention.

FIG. 3 is a front view of a water tank of the present invention.

FIG. 4 is a front view of a second suction port for polluted air of the present invention.

FIG. 5 is a front view of a secondary purifying and spraying chamber of the present invention.

FIG. 6 is a front view of a water droplet blocking chamber of the present invention.

FIG. 7 is a front view of a whirlwind generating apparatus body of the present invention.

FIG. 8 is a front view of a whirlpool discharging apparatus of the present invention.

FIG. 9 is a side view of an inner side of a water ejection adjusting tool of the present invention.

### BEST MODEL

### Mode for Invention

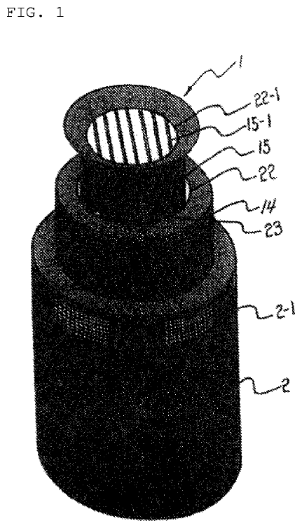

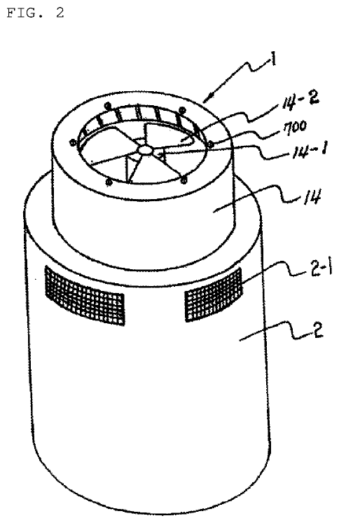

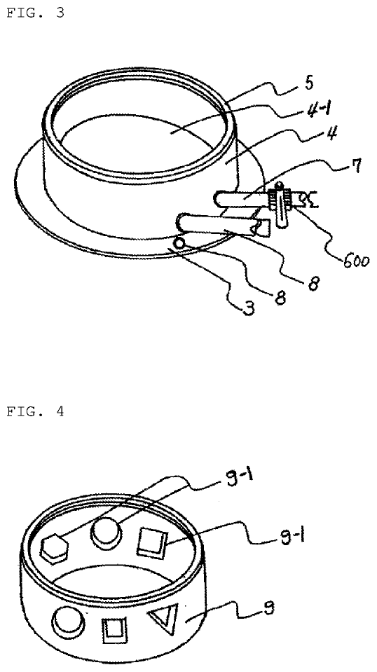

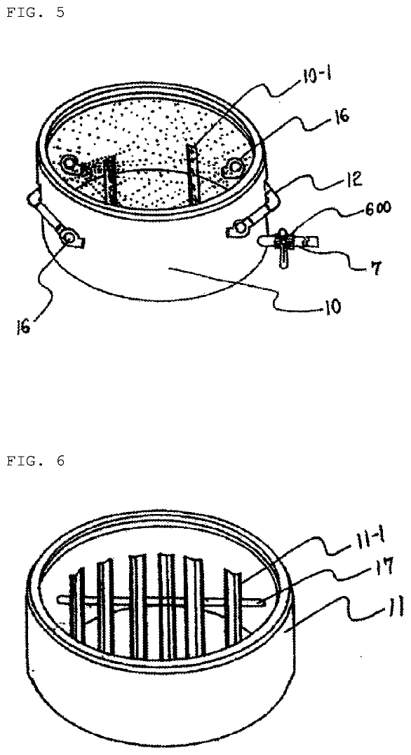

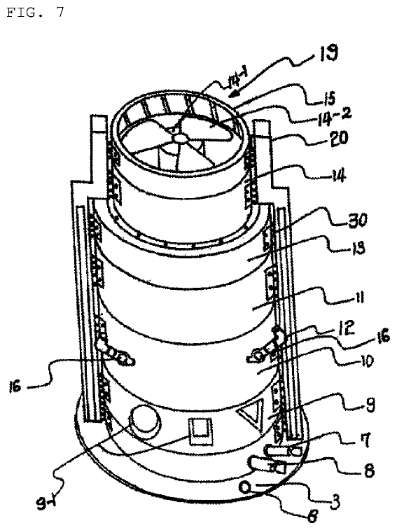

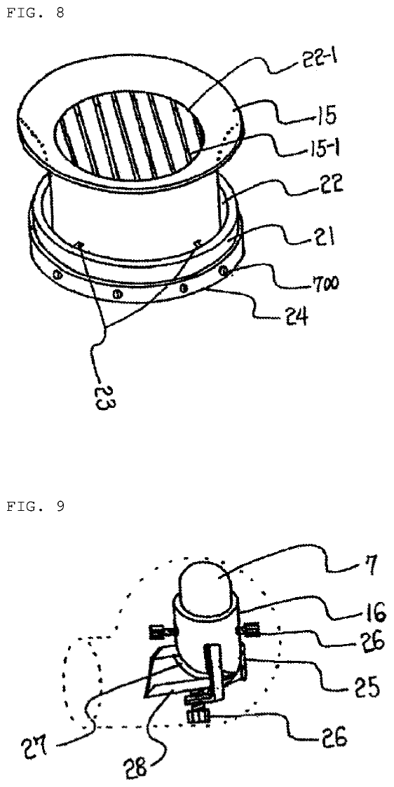

The present invention relates to a whirlwind-generating apparatus manufacturing method 1 that widely purifies polluted air 1000 by expanding atmospheric layers in the Earth's atmospheric environment in which multiple atmospheric layers are formed and disappeared and the atmospheric layers are changed depending on the gravity and the climate. According to the manufacturing method of the present invention, it may be durable to manufacture the apparatus formed of iron materials, non-iron materials, alloy materials, and resin materials, and more specifically, aluminum materials, stainless steel materials, zinc materials, FRP materials, PP materials, and resin-mixed materials, beam steel materials, titanium materials, iron-resin mixed materials, and non-iron-resin mixed materials that are resistant to water and saline water. Purchases required for the system, such as electric control boxes, control devices, cameras, autonomous driving devices, artificial intelligence electronic devices, oxygen generators, automatic control devices, distribution boards, safety devices, high-pressure motor pumps 500, wires, communication lines, and pipes for spray frame 12, may be used by expert personnel upon order. Subordinately purchased items used in the present invention may be purchased in bulk. Next, in order to easily describe the manufacturing method of the present invention, the manufacturing method by selecting only the hygienic stainless steel and steel materials will be described. For convenience, general welding, special welding, argon welding, stainless steel welding, and laser welding commonly used in the present invention are collectively referred to as welding. As shown in FIG. 1, the apparatus of the present invention may be formed in a circular or square shape, or may be formed externally in an angular shape such as a pentagonal, hexagonal, heptagonal, octagonal, or decagonal shape. For convenience, all cutting devices, such as an oxygen cutter, a laser cutter, a plasma cutter, and a hydraulic cutter, used for cutting in the present invention will be collectively referred to as a cutter. For convenience, electricity, a solar cell, a generator, hydrogen electricity, wind electricity and the like used in the present invention will be collectively referred to as a power source. For convenience, a derrick, a hoist, a crane, a chain block, a lift, and an elevator used for the manufacturing method of the present invention will be collectively referred to as a moving device in installation and use thereof. Configurations and drawings are attached for further description of the present invention. According to embodiments manufactured according to the configuration and structure of the present invention, a steel beam support and a whirlwind generating apparatus support 20 are fixed at predetermined positions on a concrete base in which internal and external foundations are constructed and a purifying water pipe 7 and a drain pipe 8 are buried, a base plate 3 for supporting the inside and outside of a polluted air purification discharging apparatus 1 is formed using a stainless steel plate according to a predetermined size and capacity, a size and a position of a whirlwind generating apparatus body 19 are marked at an exact center of a predetermined position on the base plate 3, one or more purifying water pipes 7 and drain pipes 8 are formed inside and outside the whirlwind generating apparatus body 19, respectively, with predetermined sizes, the body has the same circumference from a first-stage water tank 4 to a fifth-stage purified air suction chamber at the position of the whirlwind generating apparatus body 19 marked therein so that a stainless steel plate is cut by using a cutter to have a predetermined same length and the stainless steel plate is cut by the cutter to allow a higher stage to have a greater height with a predetermined value, both opposite sides of the stainless steel plate are attached and fixed to each other by welding, the both opposite sides of the stainless steel plate are attached to each other using a bending machine and fixed by welding to form a cylinder so as to be placed at the internal first-stage position marked on the base plate 3, a circumference of the cylindrical bottom ground surface of the first-stage water tank 4 is fixed by welding to prevent leakage, the circular stainless steel plate is made to fit the inner area of the water tank 4 and is fixed at an angle of more than 5° on the opposite side from the drain hole 8 formed inside the water tank 4 by welding to prevent water leakage, a water tank supporter and a stainless steel pipe band are welded at an upper end of the water tank 4 to form a block border 5 around a block border 5 line marked with a predetermined size on the cylindrical outer surface of the water tank 4 at an upper end of the water tank 4, a predetermined length value is marked on the stainless steel plates from the second-stage to the fifth-stage of the same cylinder length to cut the plates together, a predetermined shape of and a predetermined number of second suction ports 9-1 are marked at a predetermined position on outer side surfaces of the cylindrical stainless steel plate for manufacturing a second-stage second suction chamber 9, the cylinders are formed from the second to fifth stages through bending machine work and welding work, cylinder symbols are marked on the second to fifth stage cylinders, stainless steel concave bands are formed at the bottoms of the second to fifth stage cylinders to have predetermined values and lengths equal to the thickness of the cylindrical stainless steel plate, so as to be fixed at predetermined positions on the inner and outer surfaces at the bottom end of the cylinder by welding to form a concave border 6 for accommodating the first-stage block border 5, a stainless steel band is formed with a predetermined size at an end of an upper part of the cylinders from the second-stage to fourth-stage to form a block border 5 that is stored in the concave borders 6 formed at the bottom of the cylinder, and the second suction port 9-1 is formed by cutting out the cylinder according to the shape and size marked on the second-stage cylinder, in which the combined total area of the predetermined number of second suction ports 9-1 formed on the second-stage cylindrical circumferential surface is equal to or larger than the horizontal circumference of a blower motor chamber 14 installed at the top. The completed second stage is moved and stacked on the first stage, the connection part between the block border 5 and the concave border 6, which are stacked and combined, is treated by welding or silicone work to prevent leakage of water 100 and 200, a spray frame 12 assembled therein with a precisely assembled water ejection adjusting tool 16 provided inside the cylinder of the third-stage purifying and spraying chamber 10 is fixed in a predetermined shape at a predetermined position inside the cylinder using welding or a fixing hook, a water reflection plate 10-1 precisely formed of a metal plate, is fixed at a predetermined position by welding, the completed third-stage purifying and spraying chamber 10 is stacked on the second stage, the joint between the block border 5 and the concave border 6 is completed by welding or silicone work, and thus a prepared supports are attached when the stages from the first-stage, the second-stage and the third-stage are stacked up to sixth-stage. An angle of 50 to 100 degrees is precisely formed with a mold at a predetermined position inside the fourth-stage water droplet blocking chamber 11, each unit of 5 units or more has through-holes at both ends through which purified discharging water flows, the water droplet blocking chamber 11 is completed by welding at a predetermined marking position, stacked on the third-stage, the joint parts are fixed by welding or silicone work, the cylinder of the fifth-stage purified air suction chamber 13 is used and placed on the upper block frame 5 of the fourth-stage, the joint parts are fixed by welding or silicone work, the stainless steel plate is cut by the cutter with a predetermined size and depth so that the sixth-stage blower motor chamber 14 is smaller than the purified air suction chamber 13, a cylinder is formed by using the banding machine to have both end surfaces fixed by welding, two or more supports for the blower motor 14-1 are formed horizontally at a predetermined position inside the marked cylinder, the purchased blower motor 14-1 is fixed using a bolt to the prepared fixing hook, attached thereon with a fan 14-2, and seated on a purified air discharging port support formed on the fifth-stage so as to be fixed with bolts, nuts or screws 700 and silicon formed on a fixing frame 18, walls formed of stainless steel plates are formed inside and outside the seventh-stage whirlwind generating apparatus housing 2 upon having a large structure for covering the whirlwind generating apparatus support 20 and the whirlwind generating apparatus body 19 to form a frame of the whirlwind generating apparatus body 19, the whirlwind generating apparatus is formed to fit an outer surface of the base plate 3, and one or more first suction ports 2-1 are formed around the circumference at the bottom of the whirlwind generating apparatus housing, in which the total combined area of the first suction ports 2-1 is equal to or larger than an area of the horizontal circumference of the blower motor chamber 14. A bird and insect blocking net 2-3 formed of stainless steel is installed at the first suction port, the inner and outer lower end surfaces between the base plate 3 and the whirlwind generating apparatus housing 2 are completed through welding work, piece work, and silicone work, and then the spray frame is formed at a predetermined position inside the sealed whirlwind generating apparatus housing 2, the pipe 7 is connected to the purifying water pipe 7 and the spray frame 12 formed inside the whirlwind generating apparatus housing 2, and auxiliary devices, such as doors, cleaning devices, inspection paths, and elevators, may be purchased and installed depending on the capacity and size. An act of diluting, combining, installing, or connecting an autonomous driving device, an artificial intelligence electronic device, an oxygen generator, an oxygen collector, a carbon dioxide collector, a gaseous compound collector, a gaseous compound discharger, plant cell decomposition extract, chemical scent, plant scent, various disinfectants, toxic substances harmful to the human body is prohibited except for the present inventor. The explanation of the reference numerals known to those skilled in the art has been omitted. In order to manufacture the eighth-stage whirlwind discharging apparatus 15, a predetermined stainless steel cylinder is formed, whirlwind blades 15-1 precisely formed using a mold are fixed by welding at marked fixing positions for the whirlwind blades 15-1 at regular intervals inclined at an angle of 5° or more, the completed whirlwind discharging apparatus 15 is moved and fixed on the fixing frame 18 provided in the seventh-stage, a purified air whirlwind discharging apparatus 22 replaceable thereto is formed with a discharging cylinder 21 having the same circumference as the whirlwind discharging apparatus 15 at a predetermined height, a whirlwind barrel 21-1 is formed one-tenth less than the horizontal circumference of the discharging cylinder 21, the circumference is set to be smaller and the height (length) is set to be higher to form the whirlwind barrel 2-1, the whirlwind blades 15-1 are precisely formed by the mold inside an upper part of the whirlwind barrel 21-1 to fix the marked whirlwind blades 15-1 by welding at regular intervals in one direction inclined at least 5°, the whirlwind barrel 21-1 is inserted into a predetermined position of a connection support plate 23 formed inside the discharging cylinder 21, contact surfaces between the connection support plate 23 and the whirlwind barrel 21-1 are fixed by welding, the purified air discharging apparatus 1 is completed by welding and fixing a trumpet frame to the upper end of the whirlwind barrel 21-1 to have a predetermined size rounded by the banding machine to connect the purifying water pipe 7, electrical wires, communication wires, and facility wires are completed, auxiliary parts used for the purified air whirlwind generating apparatus 1 are purchase and attached, and it is checked whether the power supply, purifying water 100, 200 and 250, and each system have no problem, thereby completing the whirlwind-generating apparatus manufacturing method of the present invention preferably operated as shown in FIG. 1.

### INDUSTRIAL APPLICABILITY

The present invention may cleanly and clearly purify the polluted air due to the pollution in the Earth's atmospheric environments, such as yellow dust, fine dust, ultrafine dust, carbon dioxide, dust, automobile emissions, industrial emissions, aviation emissions, airship emissions, agricultural machinery emissions, subway emissions, forest fires, fire pollution, viruses, harmful bacteria, and smog. In addition, harmony with nature, earth law, and earth jurisprudence have been discussed at the United Nations positioned as a center of the world, sustainable development goals have been announced at the World Commission on Environment and Development and the Rio Conference, and the human environment conferences have been held. In March 2000, the Earth Charter was proclaimed and Earth Day was enacted. In addition, the International Union for Conservation of Nature was established. People fail to purify the air pollution that is being emitted even at this very moment, and cannot think of a way for the purification, either. Since there are too many polluted air emissions for nature to purify all the polluted air, the nature is assisted to do its work when the polluted air is purified by disclosing the method for manufacturing a whirlwind generating apparatus for purifying a polluted air of the present invention so as to overcome the global crisis of greenhouse gases and climate change. In the Earth's atmospheric environment, multiple atmospheric layers are formed and disappeared and change depending on the gravity and the climate. The installation locations of the present invention, such as urban areas, residential areas, industrial areas, industrial complexes, schools, hospitals, military bases, nursing homes, department stores, terminals, waiting rooms, building interiors, large building interiors, underground shopping areas, markets, tunnels, rivers, sea, fields and mountains on the land, and areas or places with heavily polluted air 1000, are the largest business target in the industry, and required to be quickly implemented as a top priority industry by the modern society and each country in order to contribute to the country, humanity, and nature.

### DESCRIPTION OF REFERENCE NUMERALS

[Description of Reference Numerals]

| | |
|---|---|
| 1: Method for manufacturing whirlwind generating apparatus | |
| for purifying polluted air | |
| 2: Whirlwind generating apparatus housing | |
| 2-1: First suction hole | |
| 2-2: Primary purifying and spraying chamber | |
| 2-3: Blocking net | 3: Base plate |
| 4: Water tank | 4-1: Water guide plate |
| 5: Block border | 6: Concave border |
| 7: Purifying water pipe (water pipe) | |
| 8: Drain hole | 9: Second suction chamber |
| 9-1: Second suction port | |
| 10: Secondary purifying and spraying chamber | |
| 10-1: Water reflection plate | |
| 11: Water droplet blocking chamber | |
| 11-1: Water droplet blocking angular pole | |
| 12: Spray frame | 13: Purified air suction chamber |
| 14: Blower motor chamber | 14-1: Blower motor |
| 15: Whirlwind generating apparatus body | |
| 20: Whirlwind generating apparatus support | |
| 21: Discharging cylinder | 21-1: Whirlwind barrel |
| 22: Purified air whirlwind discharging apparatus | |
| 22-1: Primary purified air discharging port | |
| 22-1: Secondary purified air discharging port | |
| 23: Connection support plate | 24: Fixed external cover |
| 25: Movable hinge | 26: Bolt |
| 27: Water discharging port | 28: Spray control base |
| 29: Housing border | 30: Support plate |
| 100: Drinking water | 100-1: Tap water |
| 100-2: Spring water | 100-3: Underground water |
| 100-4: Bedrock water | |
| 200: Alternative purifying water | |
| 200-1: Sea water | 200-2: Saline water |
| 200-3: River water of second quality or higher | |
| 250: Necessary water | |
| 250-1: River water of third quality | |
| 400: Tap water pressure | 500: High pressure motor pump |
| 600: Valve | 700: Screw |
| 800: Drainage purification tank | |
| 1000: Polluted air | 200: Purified air |
| 3000: Flowing water type | |

1. A method for manufacturing a whirlwind generating apparatus for purifying polluted air by sucking polluted air in an area having the highly polluted air (1000) and specifying clean water as purifying water to purify the polluted air to assist a sky to purify the polluted air in Earth's atmosphere in which multiple atmospheric layers are formed and disappeared in an Earth's atmospheric environment, the atmospheric layers are change depending upon gravity and climate, and rain and snow are fallen from the sky so as to overcome global crisis of climate change, the method comprising, as a total of eight stage components of six internal stages and two external stages:
a first-stage water tank;
a second-stage second suction chamber;
a third-stage purifying and spraying chamber;
a fourth-stage water droplet blocking chamber;
a fifth-stage purified air suction chamber;
a sixth-stage blower motor chamber;
a seventh-stage whirlwind generating apparatus housing; and
an eighth-stage whirlwind discharging apparatus (purified air whirlwind discharging apparatus), wherein
the whirlwind generating apparatus for purifying the polluted air is manufactured in a stacked or integrated manner, only purifying water (100, 200 and 250) are used as the purifying water, an installation area or location is determined by either a fixed purification scheme or a movable purification scheme, in which a capacity and a size are determined to purify the polluted air on land, field, mountain, sea, and river, or the installation is performed indoors and outdoors in urban areas, commercial areas, residential areas, apartment complexes, shopping malls, schools, building interiors, large building interiors, underground shopping malls, subway stations, tunnels, hospitals, department stores, nursing homes, and waiting rooms to cleanly and clearly purify the polluted air.

2. The method of claim 1, wherein an internal water tank is formed on a base plate and a separate water guide plate is formed inside the water tank, so that purified drain water continuously flows in a flowing manner into a drain hole without stagnant water.

3. The method of claim 1, wherein one or more second suction ports are formed on a front circumference of a cylinder of the second suction chamber by using various models so as to suck the polluted air.

4. The method of claim 1, wherein the polluted air continuously sucked in by water ejected from a water ejection adjusting tool of an ejection frame installed inside a purifying and spraying chamber is first hit and purified, and a water reflection plate is precisely formed to allow the ejected water to second purify the polluted air so that the polluted air is second hit and purified by the purifying water sprayed after colliding with and reflected from the water reflection plate.

5. The method of claim 1, wherein circular discharging ports are precisely formed at both ends of a water droplet blocking angular pole angled at an angle of 50° or more inside the water droplet blocking chamber to prevent water droplets.

6. The method of claim 1, wherein the purified air suction chamber is formed to define an air space in which the water or the water droplets ejected as the purifying water fall into and flows to the water tank and allowing purified air to be collected in the space and sucked upward by a blower suction power.

7. The method of claim 1, wherein the blower motor chamber is formed to have a circumference smaller than the purified air suction chamber so that the purified air is slowly discharged after being sucked in rapidly through a discharging port.

8. The method of claim 1, wherein the whirlwind discharging apparatus is formed to allow a small amount of the purified air from which the polluted air is purified to be discharged into a primary purified air discharging port, and a secondary purified air discharging port discharges a large amount of the purified air discharged by a 360° whirlwind blade elaborately formed inside the whirlwind discharging apparatus while generating a whirlwind.

9. The method of claim 1, wherein a whirlwind generating apparatus housing is formed to form a first and a blocking net around the whirlwind generating apparatus housing, so as to be covered on the sixth stage of a whirlwind generating apparatus body to generate a sealed space to define a first purifying and spraying chamber, thereby purifying polluted air sucked into a first suction port.

10. The method of claim 1, wherein the movable purification scheme, the whirlwind generating apparatus for purifying the polluted air, and a purchased and prepared drainage purification tank are provided to purify the polluted air in combination at sea or on river.

11. The method of claim 1, wherein a water ejection adjusting tool is precisely formed to eject the purifying water to hit and purify the polluted air.

12. The method of claim 1, wherein an act of diluting, combining, installing, or connecting an autonomous driving device, an artificial intelligence electronic device, an oxygen generator, an oxygen collector, a carbon dioxide collector, a gaseous compound collector, a gaseous compound discharger, plant cell decomposition extract, chemical scent, plant scent, various disinfectants, toxic substances harmful to a human body is prohibited except for the present inventor.

13. The method of claim 1, wherein the polluted air is purified more effectively using a car trailer purification scheme, a road moving purification scheme, a rail moving purification scheme, an elevator moving purification scheme, and a tilting rotation purification scheme.

14. The method of claim 1, wherein the purifying water (100, 200 and 250) includes purifying water (100) limited to drinking water (100) permitted by the country, such as tap water, spring water, groundwater and bedrock water; alternative purifying water (200) such as sea water, saline water, and river water as water of second quality or higher permitted by the country; and necessary water (250), in areas and places without the above purifying water, limited to water of third quality permitted by the country.
